(19) United States
(12) Patent Application Publication
(10) Pub. No.: US 2004/0024743 A1
(43) Pub. Date: Feb. 5, 2004

(54) File storage device, program for controlling file storage device, computer readable recording medium on which the program is recorded, and printing system

(75) Inventor: Takeshi Kato, Kawasaki-Shi (JP)

Correspondence Address: BURNS DOANE SWECKER & MATHIS L L P, POST OFFICE BOX 1404, ALEXANDRIA, VA, 22313-1404, US

(73) Assignee: MINOLTA CO., LTD.

(21) Appl. No.: 10/629,792

(22) Filed: Jul. 30, 2003

(30) Foreign Application Priority Data
Jul. 30, 2002 (JP) 2002-221459

(51) Int. Cl. G06F 7/00

(52) U.S. Cl. 707/1

(57) ABSTRACT

A file is capable of extracting text information for a specified file and transmitting it to a portable terminal based on a request from the potable terminal. The file server is also capable of generating an aggregate image where a plurality of thumbnail images are arranged within the same page for a specified file and transmitting it to a printer based on a request from a portable terminal. The file server is further capable of generating an enlarged image of a thumbnail image for a specified file and transmitting it to a portable terminal after transmitting the thumbnail image based on a request from the portable terminal.

This application is based on Japanese Patent Application No. 2002-221459, filed on Jul. 30, 2002, the contents of which are hereby incorporated by reference.

### BACKGROUND OF THE INVENTION

1. Field of the Invention

The invention relates to a file storage device, a program for controlling a file storage device, a computer readable recording medium on which the program is recorded, and a printing system. The invention particularly relates to a file storage device used in a printing system comprising the file storage device for storing a file, a printing device communicable with the file storage device, and a portable terminal communicable with the file storage device, wherein a file stored in the file storage device can be printed by the printing device based on an instruction from the portable terminal.

2. Description of the Related Art

Various services using portable terminals are proposed as mobile computing development is continuing.

As a usage mode of the portable terminals, one can cite a technology that causes a printer closest to the user's current location to print a file stored in a file storage device, such as a file server that the user normally uses, based on an instruction from a portable terminal. This makes it possible for the user to obtain easily necessary information as a printed matter whenever and wherever the user desires.

However, the display screen of a portable terminal is small and there is a limit to its memory capacity and its communication speed, so that, practically speaking, it is difficult to confirm the contents of the file to be printed on the portable terminal's screen prior to printing. As a result, there is a possibility of printing a wrong file, which results in a waste of printed matter and an unnecessary cost if printing is charged.

### SUMMARY OF THE INVENTION

It is an object of the present invention to provide a file storage device, a program for controlling the file storage device, a computer readable recording medium on which the program is recorded, and a printing system, which are improved for solving the above mentioned problem.

It is a more detailed object of the invention to provide a file storage device, a computer readable recording medium on which the program is recorded, and a printing system, which are capable of allowing the user to identify easily and securely the contents of the file stored in the file storage device.

According to an aspect of the invention, there is provided a file storage device that is capable of communicating with a portable terminal, comprising: a text information extracting part for extracting text information for a specified file in response to a request from the portable terminal; and a text information transmitting part for transmitting the text information extracted by the text information extracting part to the portable terminal.

According to this invention, the user can easily and securely recognize the contents of an intended file among the files stored in the file storage device. Consequently, it prevents the user from inadvertently making an error of printing an unintended file and the generation of an unnecessary printing cost.

According to another aspect of the invention, there is provided a file storage device that is capable of communicating with a portable terminal and a printing device, comprising: an aggregate image generating part for generating an aggregate image consisting of a plurality of thumbnail images arranged within the same page for a specified file in response to a request from the portable terminal; and an aggregate image transmitting part for transmitting the aggregate image generated by the aggregate image generating part to the printing device.

According to still another aspect of the invention, there is provided a file storage device that is capable of communicating with a portable terminal, comprising: a thumbnail image transmitting part for transmitting a thumbnail image for a specified file to the portable terminal in response to are quest from the portable terminal; an enlarged image generating part for generating an enlarged image for the thumbnail image in response to a request from the portable terminal; and an enlarged image transmitting part for transmitting the enlarged image generated by the enlarged image generating part to the portable terminal.

According to a further aspect of the invention, there is provided a printing system, comprising: a file storage device for storing a file; a printing device communicable with the file storage device; and a portable terminal communicable with the file storage device, wherein a file stored in the file storage. device is printed by the printing device based on an instruction from the portable terminal; the file storage device including: a text information extracting part for extracting text information for a specified file in response to a request from the portable terminal; and a text information transmitting part for transmitting the text information extracted by the text information extracting part to the portable terminal; the portable terminal including: a display part for displaying the text information received from the file storage device.

According to a still further aspect of the invention, there is provided a printing system, comprising: a file storage device for storing a file; a printing device communicable with the file storage device; and a portable terminal communicable with the file storage device, wherein a file stored in the file storage device is printed by the printing device based on an instruction from the portable terminal; the file storage device including: an aggregate image generating part for generating an aggregate image consisting of a plurality of thumbnail images arranged within the same page for a specified file in response to a request from the portable terminal; and an aggregate image transmitting part for transmitting the aggregate image generated by the aggregate image generating part to the printing device, the printing device including: a printing part for printing the aggregate image received from the file storage device.

According to a yet further aspect of the invention, there is provided a printing system, comprising: a file storage device for storing a file; a printing device communicable with the file storage device; and a portable terminal communicable with the file storage device, wherein a file stored in the file storage device is printed by the printing device based on an instruction from the portable terminal; the file storage device including: a thumbnail image transmitting part for transmitting a thumbnail image for a specified file to the portable terminal in response to are quest from the portable terminal; an enlarged image generating part for generating an enlarged image for the thumbnail image in response to a request from the portable terminal; and an enlarged image transmitting part for transmitting the enlarged image generated by the enlarged image generating part to the portable terminal; the portable terminal including: a display part for displaying the thumbnail image and the enlarged image received from the file storage device.

According to a yet further aspect of the invention, there is provided a program for controlling a file storage device that is capable of communicating with a portable terminal, wherein the program causes the file storage device to execute a process comprising the steps of: 1) extracting text information for a specified file in response to a request from the portable terminal; and 2) transmitting the text information extracted in step 1) to the portable terminal.

According to a yet further aspect of the invention, there is provided a program for controlling a file storage device that is capable of communicating with a portable terminal and a printing device, wherein the program causes the file storage device to execute a process comprising the steps of: 1) generating an aggregate image consisting of a plurality of thumbnail images arranged within the same page for a specified file in response to a request from the portable terminal; and 2) transmitting the aggregate image generated in step 1) to the printing device.

According to a yet further aspect of the invention, there is provided a program for controlling a file storage device that is capable of communicating with a portable terminal, wherein the program causes the file storage device to execute a process comprising the steps of: 1) transmitting a thumbnail image for a specified file to the portable terminal in response to a request from the portable terminal; 2) generating an enlarged image for the thumbnail image in response to a request from the portable terminal; and 3) transmitting the enlarged image generated in step 2) to the portable terminal.

The objects, characteristics and properties of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a printing system wherein a file server according to the first embodiment of the present invention is applied.

FIG. 2 is a block diagram showing the general constitution of a file server.

FIG. 3 is a block diagram showing the general constitution of a printer.

FIG. 4 is a block diagram showing the general constitution of a portable terminal.

FIG. 5 is a sequence chart that describes the operation of the printing system according to the first embodiment.

FIG. 6 is a flowchart that describes the process that occurs when a request of directory information is received at the file server.

FIG. 7 is a flowchart that describes the process that occurs when a request of a preview item data is received at the file server.

FIG. 8 is a flowchart that describes the process that occurs when a request of preview information is received at the file server.

FIG. 9 is a flowchart that describes the process that occurs when a printing request is received at the file server.

FIG. 10 is a diagram showing an example of text information.

FIG. 11 is a flowchart that describes the process that occurs when a request of printer information is received at the printer.

FIG. 12 is a sequence chart that describes the operation of the printing system according to the second embodiment.

FIG. 13 is a flowchart that describes the process that occurs when a printing request for an aggregate image is received at the file server.

FIG. 14 is a diagram showing an example of aggregate image.

FIG. 15 is a sequence chart that describes the operation of the printing system according to the third embodiment.

FIG. 16 is a sequence chart that describes the operation. of the printing system according to the third embodiment continuing from FIG. 15.

FIG. 17 is a flowchart that describes the process that occurs when a request of an enlarged image is received at a file server.

FIG. 18A is a diagram showing an example of thumbnail image.

FIG. 18B is a diagram for describing the procedure of generating an enlarged image.

### DETAILED DESCRIPTION OF THE PREFERRED EMBODIMENTS

The embodiments of this invention will be described below with reference to the accompanying drawings.

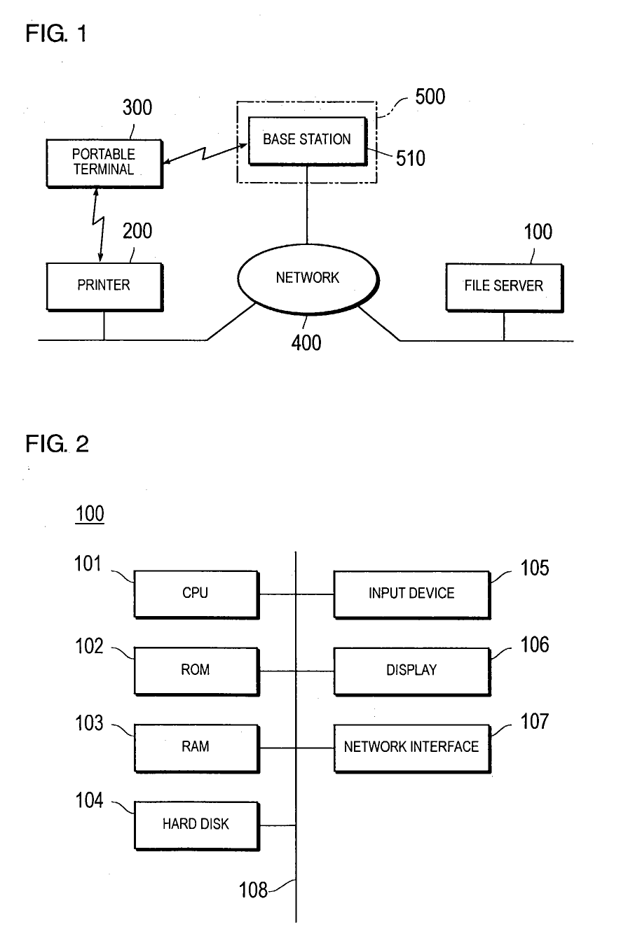

FIG. 1 is a block diagram showing the overall constitution of a printing system wherein a file server according to the first embodiment of the present invention is applied.

The printing system shown in FIG. 1 is equipped with a file server 100 that functions as a file storage device for storing files, a printer 200 that serves as a printing device capable of communicating with file server 100, and a portable terminal 300 capable of communicating with the file server 100.

The file server 100 and the printer 200 are both connected to a network 400, and are capable of communicating with each other via the network 400. The network 400 consists of LANs such as Ethernet®, Token Ring, and FDDI, or a WAN that consists of interconnected LANs, or the Internet. Moreover, the types and the number of equipment to be connected to the network 400 are not limited to those shown in FIG. 1.

The portable terminal 300 is capable of conducting a local communication between devices by locally connecting (direct connection) with the printer 200. Local communications herein mean both wireless communications and wired communications using cables. The portable terminal 300 is capable of communicating with the file server 100 connecting to the network 400 via a mobile communication network 500. The mobile communication network 500 includes a base station 510, and the connection between the portable terminal 300 and the base station 510 is a wireless section.

Next, constitution of each device mentioned above will be described below, but the description of a function common to multiple devices will be made only once when it appears and will not be repeated afterwards in order to avoid duplicate descriptions.

FIG. 2 is a block diagram showing the general constitution of the file server 100.

The file server 100 includes a CPU 101 for controlling the entire device and executing various arithmetic processes; a ROM 102 for storing various programs and data; a RAM 103 for temporarily storing various programs and data; a hard disk 104 for storing various programs and data to be read into the RAM during the CPU's executions of the programs; an input device 105 consisting of a keyboard and a mouse for inputting various instructions; a display 106 for displaying various information; and a network interface 107 such as a LAN card for connecting to the network 400, all of which are interconnected with each other via a bus 108 for exchanging signals.

The file server 100 is capable of storing files the user personally use, or files that are shared by multiple users. Such files are stored in hard disk 104. The file server 100 has a function of extracting necessary information from a specified file in response to a request from a portable terminal and transmitting it to the portable terminal; a function of converting a file into a format printable by a specified printer; and a function of transmitting the printing data obtained by the form at conversion to the specified printer, and the program for executing these functions is stored in the ROM 102 or the hard disk 104.

The file storage device of this invention does not have to be a file server shared by multiple users but rather can be, for example, a personal computer (PC) that each user uses as long as it has the abovementioned functions. Also, an MFP (Multi-Function Peripheral) and even a printer can be used as a file storage device. The file storage device is not limited to a case in which it is connected to a LAN, but it can exist on the Internet.

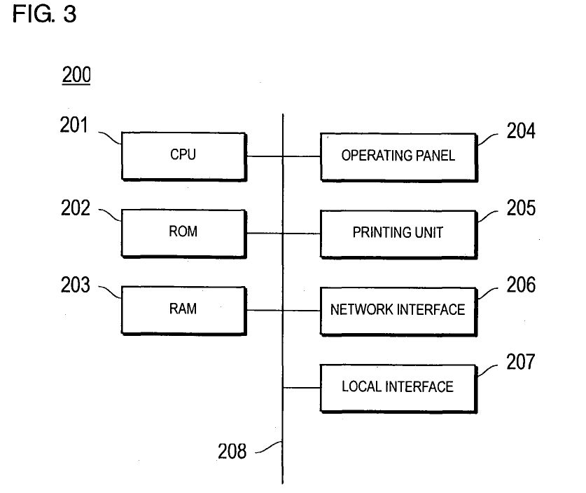

FIG. 3 is a block diagram showing the general constitution of the printer 200.

The printer 200 includes a CPU 201, a ROM 202, a RAM 203, an operating panel 204, a printing unit 205, a network interface 206, and a local interface 207, all of which are interconnected with each other via a bus 208 for exchanging signals.

The operating panel 204 is used for various information displays and entering various instructions. The printing unit 205 prints printing data on recording media such as paper by means of a known image forming process using laser beams.

The local interface 207 is an interface for direct local communications with other devices such as the portable terminal 300, and is an interface compatible with wired communication standards such as USB or wireless communication standards such as Bluetooth® and IrDA®.

The printer 200 can communicate directly with other devices such as the portable. terminal 300 via the local interface 207. This way, the other device can easily obtain printer information, which is unique information concerning the printer.

The printer information contains the printer's address information as well as information concerning the printer's constitution and capability, and is stored in a storage unit such as ROM 202. The address information is, for example, an IP address. The information concerning the printer's constitution and capability includes where it has a double sided printing mechanism or a sorting mechanism, the model name of the printer, printing language (printable format), whether there is an instruction for color vs. monochromatic, printing method (electronic photograph type/ink jet type), printing speed, printing resolution, the size of printable paper, the type of printable paper, whether there is a scaling function, and fee information (cost per sheet of printing).

The printing device can be, in addition to a printer, a copying machine or an MFP (Multi-Function Peripheral).

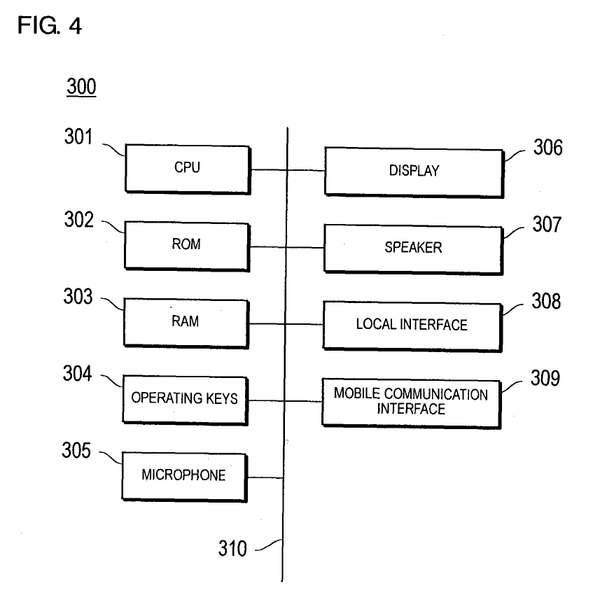

FIG. 4 is a block diagram showing the general constitution of the portable terminal 300.

The printer 300 has a CPU 301, a ROM 302, a RAM 303, operating keys 304, a microphone 305, a display 306, a speaker 307, a local interface 308, and a mobile communication interface 309, all of which are interconnected with each other via a bus 310 for exchanging signals.

The operating keys 304 are used for input of characters and numerical values, or various instructions, while the microphone 305 is used for voice inputs. The display 306 is a small liquid crystal display used for various displays. The speaker 307 is used for voice outputs.

The mobile communication interface 309 uses the electromagnetic wave of a specified frequency band, and is an interface for connecting with mobile communication network 500.

The portable terminal 300 is specifically a cellular telephone in this embodiment. In addition to a cellular phone, any portable terminal such as PHS®, PDA, a laptop computer, and an electronic notebook can be used as the portable terminal in this embodiment. The present invention provides a marked effect when it is applied to a portable terminal whose memory size or the number of displayable pixels of the screen (e.g., the number of displayable pixels is 240 * 320 dots) is limited because of its small physical size, such as a cellular telephone or PDA.

The user can operate simultaneously both the closely located printer 200 and the remotely located file server 100 by means of the portable terminal 300. Therefore, it is possible to cause the printer 200 located close to the user's current location to print a file stored in the file server 100 that is normally used by the user based on an instruction from the portable terminal 300.

The file server 100, the printer 200, and the portable terminal 300 may contain constitutional elements other than those described above, or may not include a portion of the abovementioned elements.

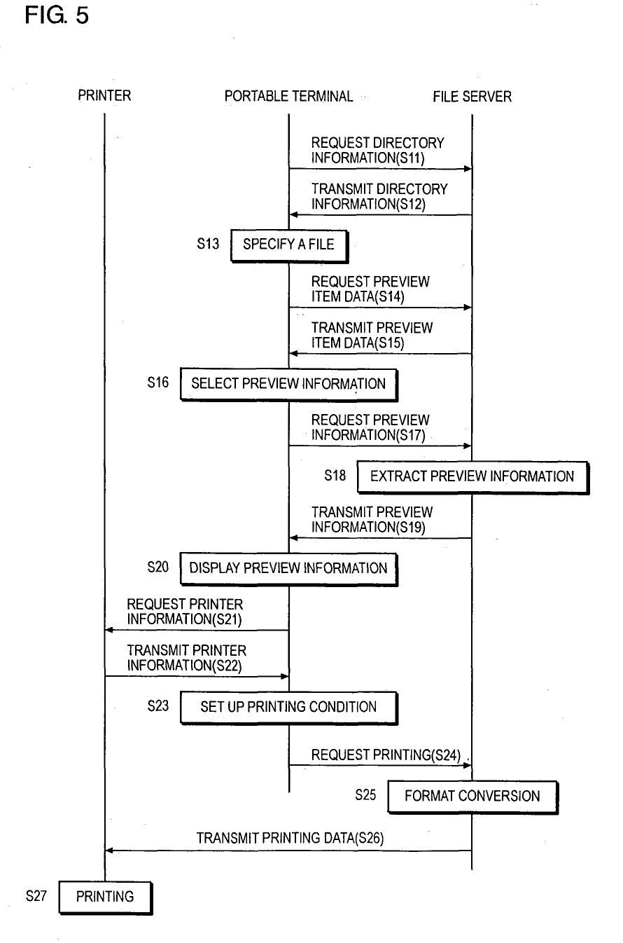

Let us describe the printing system according to the first embodiment with reference to the sequence chart of FIG. 5. Let us describe a case wherein the user confirms the contents of a file stored in the file server 100 on the display 306 of the portable terminal 300 and then the file is printed by the printer 200.

First, upon receiving a request from the portable terminal 300 (S11 ),the file server 100 transmits the directory information to the portable terminal 300 (S12). The directory information is information for managing file information shown in a hierarchical structure. As the user operates the operating keys 304 while referring to the directory information displayed on the screen of the display 306 of the portable terminal 300, a required file is specified(S13).

Next, upon receiving a request from the portable terminal 300 (S14), the file server 100 transmits a preview item data to the portable terminal 300 (S15). The preview item data is a list of types of preview information for confirming in advance the contents of a file. As the user operates the operating keys 304 while referring to the preview item data displayed on the screen of the display 306 of the portable terminal 300, one type of preview is selected (S16). Let us describe a case when “Text Information” is selected in this embodiment.

After the Text Information is selected as a preview information item, the portable terminal 300 transmits the preview information request to the file server 100 in accordance with the user's operation (S17) The file server 100 extracts the preview information for the specified file (S18), and transmits it to the portable terminal 300 (S19). The portable terminal 300 displays received preview information on the display 306 (S20). This makes it possible for the user to identify the file contents easily and securely by means of the “Text Information” displayed on the screen of the display 306 as the preview information.

Next, upon receiving a request from the portable terminal 300 (S21), the printer 200 transmits the printer information to the portable terminal 300 (S22). As the user operates the operating keys 304 while referring to the printer information displayed on the screen of the display 306 of the portable terminal 300, the printing condition required for causing the printer 200 to print is set up (S23).

After the printing condition is setup, the portable terminal 300 transmits a printing request to the file server 100 in accordance with the user's operation (S24).

The file server 100 converts the format of the specified file to a format printable by the printer 200 (S25), and transmits the printing data, which is the file obtained by the format conversion, to the printer 200 (S26). The printer 200 then prints the received printing data (S27).

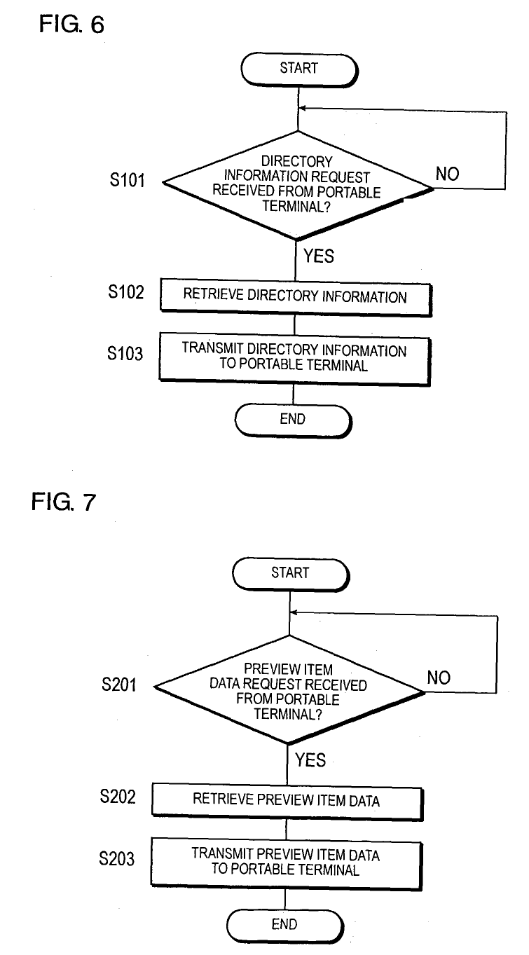

Next, the job process in the file server 100 will be described below referring to FIG. 6 through FIG. 10. The algorithm shown in the flowcharts of FIG. 6 through FIG. 9 is stored as a program in a storage unit such as the hard disk 104 of the file server 100 and executed by the CPU 101.

First, let us describe the process when a request for the directory information is received at the file server 100 referring to FIG. 6.

The directory information request is transmitted from the portable terminal 300 via the mobile communication network 500 and the network 400 to the file server 100. When the user operates the portable terminal 300, the portable terminal 300 transmits the directory information request to the file server 100.

When a directory information request is received from the portable terminal 300 (S101: Yes), the file server 100 retrieves directory information from various data stored in a storage unit such as the hard disk 104. (S102).

The directory information includes the file name as well attribute information such as the size of the file, the type of the file, and the updated date. It is also possible to use file list information showing the file information in a list format instead of directory information showing the file information in a hierarchical structure.

The file server 100 transmits the retrieved directory information to the portable terminal 300 of the request source (S103).

When the portable terminal 300 receives the directory information, it displays the directory information on the screen of the display 306. The user can scroll the screen or generate a retrieve instruction to find the intended file manipulating the operating keys 304 of the portable terminal 300. The file to be printed is specified as the user operates the operating keys 304 while viewing the directory information. In this case, the preview information is not necessarily required, if the user can grasp the contents of the file through the directory information alone. On the other hand, if the user wishes to confirm the contents of the file in advance, it is necessary for the preview item data that shows the preview information in a list form to be displayed on the portable terminal 300.

Next, let us describe the process when a request for the preview item data is received at the file server 100 referring to FIG. 7.

The request for the preview item data is transmitted by the portable terminal 300 to the file server 100 when the user operates the portable terminal 300 while a file to be printed is specified.

When a request for the preview item data is received from the portable terminal 300 (S201: Yes), the file server 100 retrieves the preview item data from various data stored in a storage unit such as the hard disk 104 (S202).

The preview item data indicates the data extractable from a file and the data obtained by converting the file.

The data extractable from a file includes text information, graphic data, page size, number of pages, person who prepared the file, sheet name, and texts inside the cell. The text information includes, in addition to text data, those items that is a part of the text data, such as heading, table of contents, and specified page. The text information can be obtained by recognizing characters from character images in the image data included in the file. The heading herein means the title of the article contained in the data, while the table of contents is the items of the data contents listed in the order of description. These can be detected from attribute information to be added to the character code data that constitute the text data such as font size and font location.

The data that can be obtained by file conversion is, for example, a thumbnail image. The thumbnail image herein means an image obtained by reducing the size and the number of pixels of the original image data. The preview item data may indicate only a portion among the abovementioned various types of the preview information, for example, the text information.

The preview item data is prepared in a database in relation to the format of the file. Therefore, the retrieval of the preview item data is executed in accordance with the format of the file specified by the portable terminal 300.

The file server 100 transmits the retrieved preview item data to the portable terminal 300 of the request source (S203). From the standpoint of improving the convenience, it is possible to transmit the specific preview information indicated in the preview item data such as a thumbnail image simultaneously with the transmission of the preview item data.

When the portable terminal 300 receives a preview item data, it displays the preview item data on the screen of the display 306. The necessary preview information is selected as the user operates the operating keys 304 while viewing the preview item data. It can also be constituted in such a way as to be able to limit the number of pages for which the preview information is required. Moreover, it can also be constituted in such a way as to be able to specify the extraction to be made from the head of the specified page only up to the specified number of characters when text information is selected. By constituting in such a way, it is preferable as the transmission data can be minimized, in particular, when the number of pages of the file is large. In this embodiment, a case wherein text information is selected as the preview information will be described below.

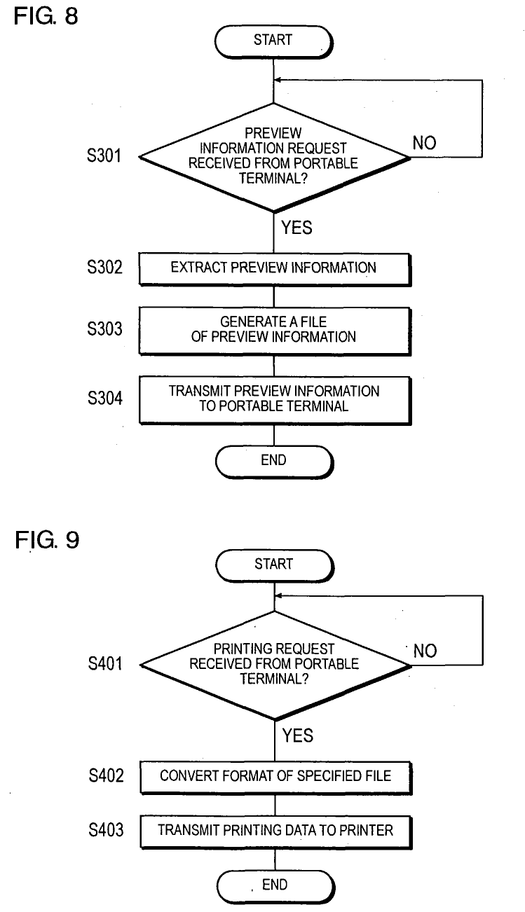

Next, let us describe the process when a request for the preview information is received at the file server 100 referring to FIG. 8.

The request for the preview information is transmitted by the portable terminal 300 to the file server 100 when the user operates the portable terminal 300 while the preview information is selected.

When a preview information request is received from the portable terminal 300 (S301: Yes), the file server 100 extracts the preview information for the file specified by the portable terminal 300 (S302).

The extracted preview information is converted into a specified format (e.g., general purpose file format such as HTML) that can be displayed on the portable terminal 300 (S303).

The file server 100 transmits the preview information converted into the specified format to the portable terminal 300 of the request source (S304).

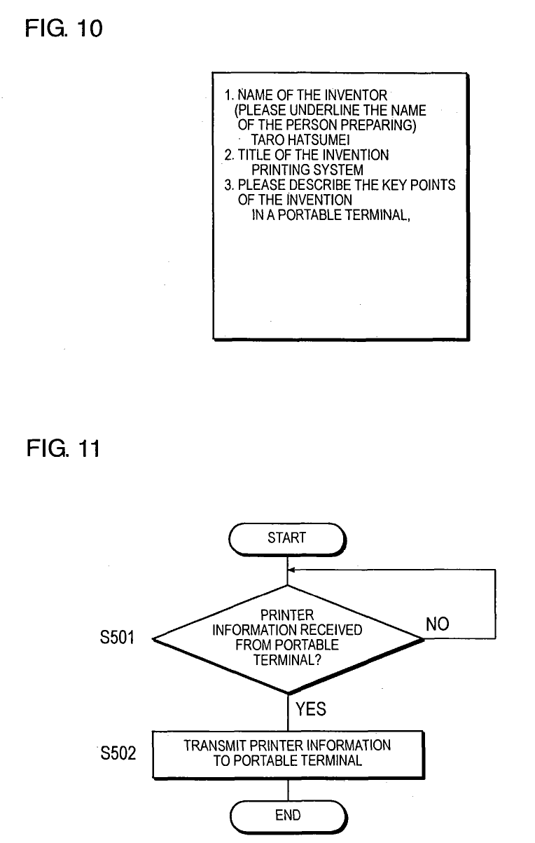

When the portable terminal 300 receives the preview information, it displays the preview information on the screen of the display 306. FIG. 10 shows an example of text information displayed on the screen of the portable terminal 300 as the preview information.

This makes it possible for the user to identify the file contents easily and securely by viewing the preview information displayed on the screen of the display 306 of the portable terminal 300. Thus, the user can confirm if the file to be printed is. a correct file. Moreover, if only a part of the file is necessary, it is possible to confirm that the portion to be printed and obtain the information for specifying the partial printing (e.g., page number).

Also, it is difficult to grasp the content by means of a thumbnail image alone particularly when the data contained in the file to be printed is a document data containing characters. To overcome such an inconvenience, the present embodiment allows the file contents to be securely identified by having the text information to be displayed on the screen of the portable terminal 300 as the preview information. Moreover, the communication time and cost can be reduced and the memory capacity of the portable terminal 300 can be minimized as well.

Next, let us describe the process when a printing request is received at file server 100 referring to FIG. 9.

The printing request is transmitted by the portable terminal 300 to the file server 100 when the user operates the portable terminal 300 while a file to be printed is specified. The printing request contains the file name of the specified file, printing condition, and the address information of the printer to be used in the printing. The printing conditions include the color/monochromatic specification, range of printing (specifying the pages) or the number of copies, and are set up by the user by means of the operating keys 304 while referring to the printer information displayed on the screen of the display 306 of the portable terminal 300. The address information of the printer to be used is included in the printer information. The printer information is transmitted in advance from the printer to be used (printer 200 in this case) based on a request from the portable terminal 300 as described later.

When a printing request is received from the portable terminal 300. (S401: Yes), the file server 100 converts the file format of the file specified by the portable terminal 300 (S402). Such a format is set up to a format that the printer 200 can understand based on the printer information obtained from the printer 200.

The file server 100 transmits the file obtained by the format conversion to the printer 200 as the printing data (S403).

The printer 200 prints the printing data received from the file server 100 on a recording medium such as paper. Therefore, the use can obtain the printed matter of the file as desired without fail. Also, in case of using an outside printing service, it is possible to avoid being charged for wrong printing.

Next, let us describe the process when a request for the printer information is received at the file server 200 referring to FIG. 11.

The printer information request is transmitted from the portable terminal 300 via the local interfaces 308 and 207 to the printer 200. The portable terminal 300 identifies here the printer 200, which is the target, by means of retrieval using, for example, a local wireless communication. When the user operates the portable terminal 300, the portable terminal 300 transmits the printer information request to the printer 200.

When the printer 200 receives a printer information request from the portable terminal 300 (S501: Yes), it transmits the printer information stored in a storage unit such as the ROM 202 to the portable terminal 300 of the request source (S502).

As can be seen from the above, in the first embodiment, the file server 100 extracts the text information concerning a specified file and transmits the text information to the portable terminal 300 based on a request from the portable terminal 300.

Therefore, the user can easily and securely identify the contents of the file in question among the files stored in the file server, as the text information can be viewed on the portable terminal 300. Consequently, it prevents the user from inadvertently making an error of printing an unintended file and the generation of an unnecessary printing cost.

Also, if the file in question is a document data that contains characters, the portable terminal can clearly display the text information on the screen so that the user can identify the contents more effectively. Moreover, the communication time and cost can be reduced and the memory capacity of the portable terminal can be minimized as well. Moreover, if the heading is selected as the text information, the file contents for each section can be confirmed quickly so that it is possible to narrow down the section to be printed.

Next, the second embodiment of the invention will be described below. The hardware constitution of the printing system according to the second embodiment is identical to that of the first embodiment. In the following, the second embodiment will be described primarily concerning the points that are different from the first embodiment and omitting the points common to both of them.

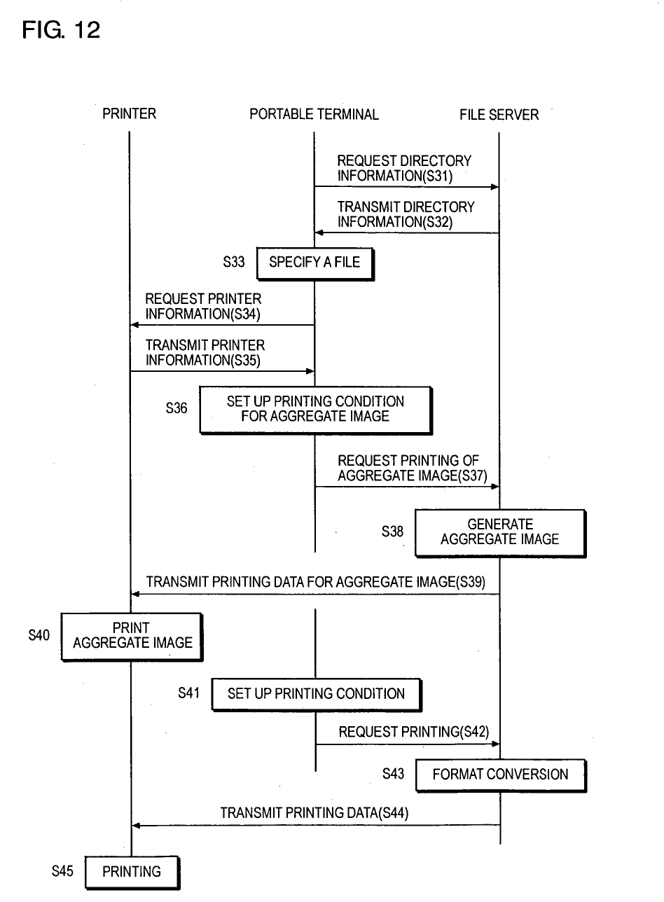

FIG. 12 is a sequence chart that describes the operation of the printing system according to the second embodiment. A case will be described below, wherein a file will be properly printed by the printer 200 only after the user causes the printer 200 to print the aggregate image for confirming the contents of the file stored in the file server 100 and confirms the contents of the file by checking the printed image.

The process of steps S31 through S33 is identical to the process of S11 through S13 shown in FIG. 5.

Next, upon receiving a request from the portable terminal 300 (S34), the printer 200 transmits the printer information to the portable terminal 300 (S35). As the user operates operating keys 304 while referring to the printer information displayed on the screen of the display 306 of the portable terminal 300, the printer condition required for causing the printer 200 to print the aggregate image concerning the specified file is set up (S36). An aggregate image herein means an image with a plurality of thumbnail images arranged within the same page concerning a specified file.

After the printing condition of the aggregate image is set up, the portable terminal 300 transmits the printing request to the file server 100 in accordance with the user's operation (S37).

The file server 100 generates the aggregate image of the specified file (S38), and transmits the aggregate image printing data, which is the file for the aggregate image, to the printer 200 (S39). The printer 200 then prints the received aggregate image printing data (S40). Thus, the user can easily and securely identify the file contents by means of the printed matter of the aggregate image printing data.

The process of steps S41 through S45 that follows is identical to the process of S23 through S27 shown in FIG. 5.

Next, let us describe the process at the file server 100.

In the second embodiment, same as in the first embodiment, the process when a directory information request is received as shown in FIG. 6 and also the process when a printing request is received as shown in FIG. 9 are executed. However, in the second embodiment, different from the first embodiment, the process when a preview item data request is received as shown in FIG. 7 and also the process when a preview information request is received as shown in FIG. 8 are not executed.

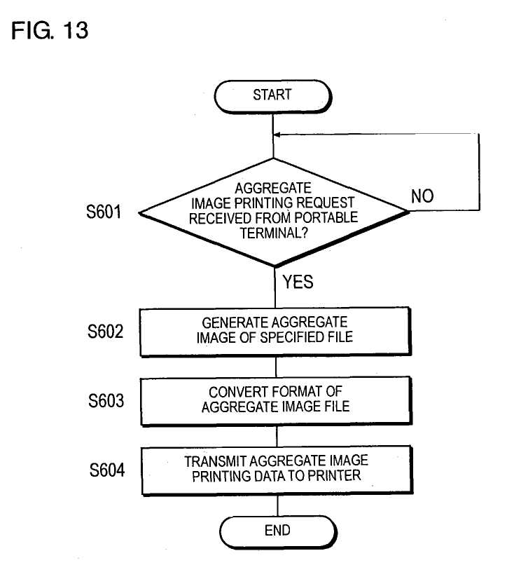

Next, let us describe the process when an aggregated image printing request is received at the file server 100 referring to FIG. 13. The algorithm shown in the flowchart of FIG. 13 is stored as a program in a storage unit such as the hard disk 104 of the file server 100 and executed by the CPU 101.

The aggregated image printing request is transmitted by the portable terminal 300 to the file server 100 when the user operates the portable terminal 300 while a file to be printed is specified. The aggregated image printing request contains the file name of the specified file, the printing conditions of the aggregated image, and the address information of the printer to be used in the printing. The printing conditions of an aggregated image include a printing range (specifying the page numbers of the original file), the number of pages of the original file to be arranged in one page of the aggregated image (or, the size of the thumbnail image, or the reduction ratio relative to the size of the original image), the color/monochromatic specification, and the printing paper size, which are set up by the user by means of the operating keys 304 of the portable terminal 300 referring to the printer information displayed on the screen of the display 306. If an image included in the original file is in color, the data quantity can be reduced and both the communication and printing costs can be reduced as well if it is converted to the monochromatic format for printing.

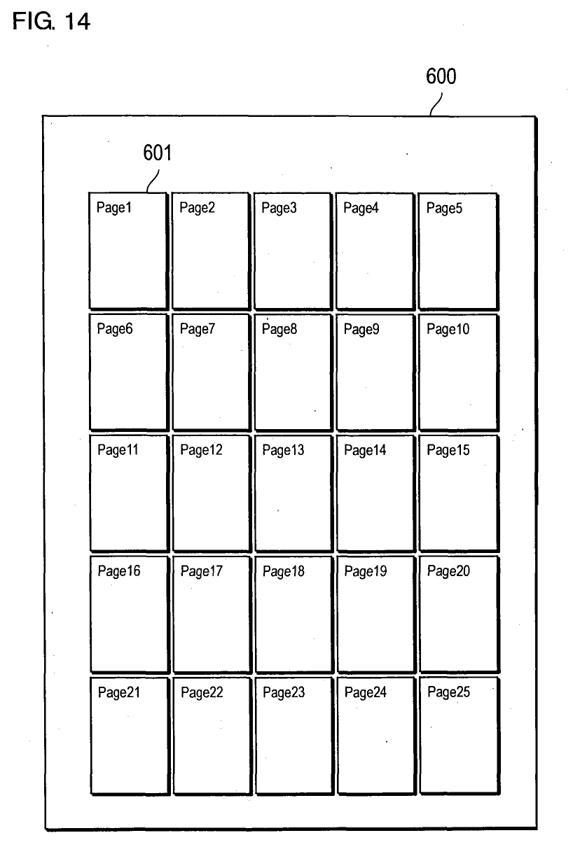

When an aggregate image printing request is received from the portable terminal 300 (S601: Yes), the file server 100 generates the aggregated image for the file specified on the portable terminal 300 (S602). FIG. 14 is a diagram showing an example of aggregate image. FIG. 14 shows the images for 25 pages of the original file reduced and arranged in one page of aggregated image. It is possible to execute the generation of the aggregate image on the printer 200 as well. However, it is preferable to generate the aggregate image on the file server 100 as the transmission data quantity can be reduced.

A file of the generated aggregate image is converted into a format that the printer 200 can understand based on the printer information obtained from the printer 200 (S603).

The file server 100 transmits the aggregate image file obtained by the format conversion to the printer 200 as an aggregate image printing data (S604).

The printer 200 prints the aggregate image printing data received from the file server 100 on a recording medium such as paper.

As can be seen from the above, in the second embodiment, the file server 100 generates an aggregate image where a plurality of thumbnail images are arranged within the same page for a specified file and transmits the generated aggregate image to the printer 200 based on a request from the portable terminal 300.

Therefore, the user can easily and securely identify the contents of the file in question among the files stored in the file server, as the user can see the printed matter of the aggregate image. Consequently, it prevents the user from inadvertently making an error of printing an unintended file and the generation of an unnecessary printing cost.

Since the images of the multiple pages of the original file can be confirmed in one page of aggregate image, it provides a high visual recognition capability and benefits in selecting necessary pages from the multiple pages of the original file. Moreover, the printed matter of the aggregate image can be used again as an index later. The thumbnail images that constitute the aggregate image can be confirmed more easily if they are printed with a high resolution printer than being displayed on a portable terminal.

Next, the third embodiment of the invention will be described below. The hardware constitution of the printing system according to the third embodiment is identical to that of the first embodiment. In the following, this embodiment will be described primarily concerning the points that are different from the first embodiment and omitting the points common to both of them.

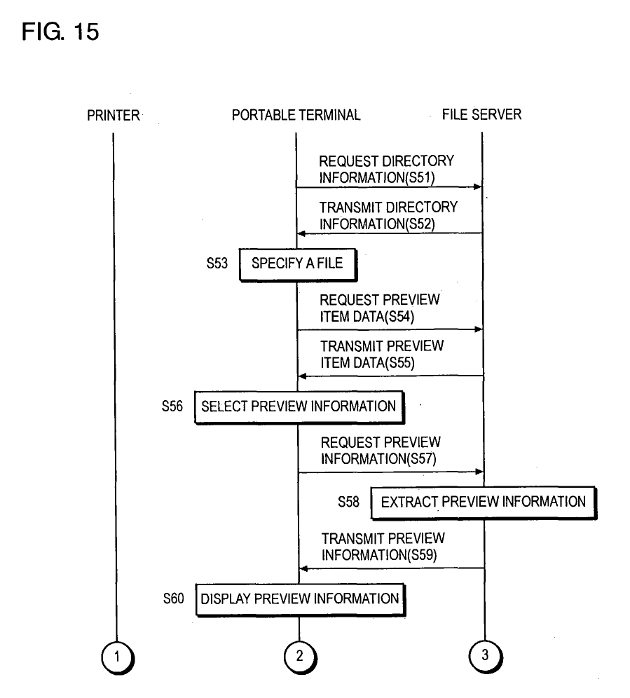

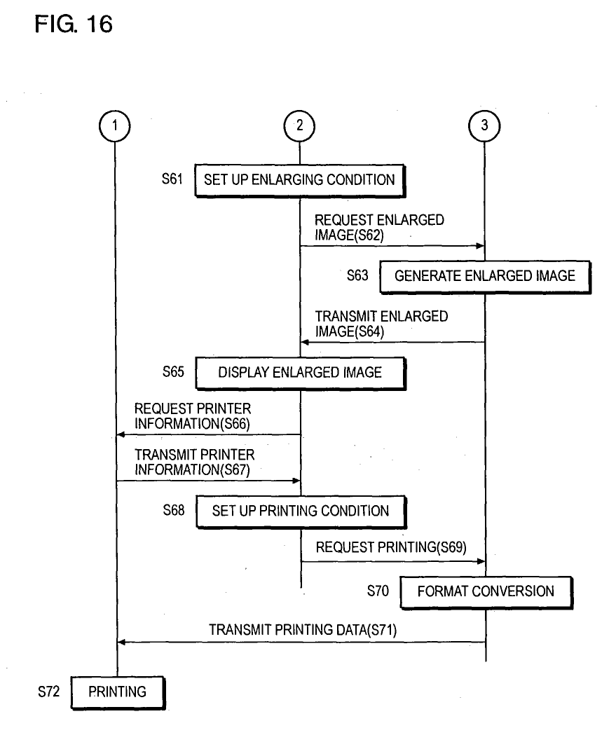

FIG. 15 and FIG. 16 show a sequence chart that describes the operation of the printing system according to the third embodiment. Let us describe a case wherein the user confirms the contents of a file stored in the file server 100 on the display 306 of the portable terminal 300 and then the file is printed by the printer 200.

The process of steps S51 through S55 is identical to the process of S11 through S15 shown in FIG. 5.

Next, as the user operates the operating keys 304 while referring to the preview item data displayed on the screen of the display 306 of the portable terminal 300, one type of preview information is selected (S56). Let us describe a case when “thumbnail image” is selected in this embodiment.

After the thumbnail image is selected as a preview information, the portable terminal 300 transmits a preview information request to the file server 100 in accordance with the user's operation (S57). The file server 100 extracts the preview information for the specified file (S58), and transmits it to the portable terminal 300 (S59). The thumbnail image to be extracted as the preview information can be prepared and stored in advance, or generated when a preview information request is received. The portable terminal 300 displays the received preview information on the display 306 (S60). This makes it possible for the user to identify the file contents roughly by means of the thumbnail image displayed on the screen of the display 306 as the preview information.

However, when it is difficult to confirm the file contents by the thumbnail image alone, the user can set up an enlarging condition for displaying an enlarged thumbnail image on the portable terminal 300 using the operating keys 304 while referring to the thumbnail image displayed on the screen of the display 306 of the portable terminal 300 (S61).

After the enlarging condition is setup, the portable terminal 300 transmits an enlarged image request to the file server 100 in accordance with the user's operation (S62). The file server 100 generates an enlarged thumbnail image for the specified file (S63), and transmits it to the portable terminal 300 (S64). The portable terminal 300 displays the received enlarged image on the display 306 (S65). This makes it possible for the user to identify the file contents easily and securely by means of the enlarged image displayed on the screen of the display 306 as the preview information. The process of steps S61 through S65 can be repeated if necessary.

The process of steps S66 through S72 that follows is identical to the process of S21 through S27 shown in FIG. 5.

Next, let us describe the process at the file server 100.

In the third embodiment, same as in the first embodiment, the process when a directory information request is received as shown in FIG. 6, the process when a preview item data request is received as shown in FIG. 7, the process when a preview information request is received as shown in FIG. 8, and the process when a printing request is received as shown in FIG. 9 is received are executed. However, the following processes are executed further in the third embodiment.

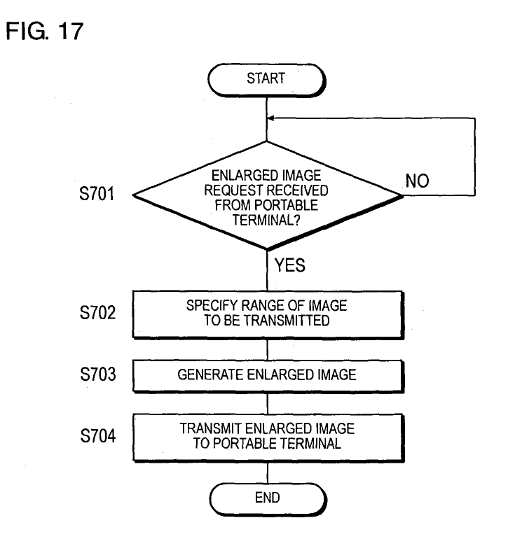

Next, let us describe the process when an enlarged image request is received at the file server 100 referring to FIG. 17. The algorithm shown in the flowchart of FIG. 17 is stored as a program in a storage unit such as the hard disk 104 of the file server 100 and executed by the CPU 101.

The enlarged image request is transmitted by the portable terminal 300 to the file server 100 when the user operates the portable terminal 300 while the enlarging condition is set up.

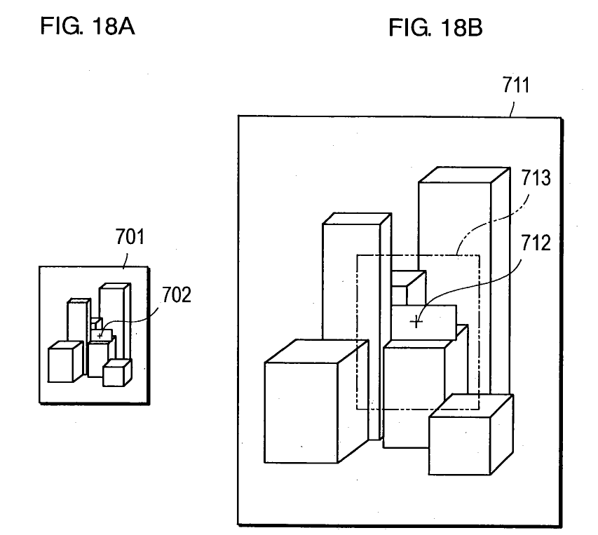

The enlarged image request includes an enlarging condition. The enlarging condition includes the coordinate of an enlargement reference point, the enlarging ratio relative to the thumbnail image, and the page number specified as the enlargement object, and is set up by the user using the operating keys 304 referring to the thumbnail image displayed on the screen of the display 306 of the portable terminal 300. As shown in FIG. 18A, for example, the enlargement reference point is specified by placing a pointer 702 in the middle of the area on the screen of the display 306 where the thumbnail image 701 is displayed. The enlargement reference point can be defined not only as the center of the area to be enlarged, but rather as the top left corner.

When an enlarged image request is received from the portable terminal 300 (S701: Yes), the file server 100 specifies the range of the image to be transmitted based on the enlarging condition (S702). In other words, the file server 100 first develops the image data of the page to be enlarged of the specified file, and then obtains a simple enlarged image by either enlarging or reducing the image data developed on the memory in correspondence with the enlarging ratio relative to the thumbnail image. As shown in FIG. 18B, for example, the file server 100 next specifies a transmission image range 713 that corresponds to an image of the size that fits the screen of the portable terminal 300 around the center with the coordinate of reference point 712 in a simple enlargement image 711. The transmission image range 713 depends on the display capability and the memory capacity of the portable terminal 300. Therefore, the image size that the portable terminal 300 can receive is also included in the enlarged image request.

Next, the file server 100 generates an enlarged image of the specified format by extracting the transmission image range 713 from the simple enlargement image 711 (S703). The file server 100 then transmits the enlarged image to the portable terminal 300 of the request source (S704).

When the portable terminal 300 receives the enlarged image, it displays the enlarged image on the screen of the display 306. If there is enough margins in the memory capacity and the communication speed of the portable terminal 300, the file server 100 may transmit a simple enlargement image 711 of the specified page in its entirety to the portable terminal 300. In this case, the user can view the simple enlargement image 711 scrolling on the screen of the display 306 of the portable terminal 300.

As can be seen from the above, in the third embodiment, the file server 100 transmits the thumbnail image for a specified file to the portable terminal 300 based on a request from the portable terminal 300. Moreover, the file server 100 generates an enlarged image of the thumbnail image and transmits the enlarged image thus generated to the portable terminal 300 based on a request from the portable terminal 300.

Therefore, the user can easily and securely identify the contents of the file in question among the files stored in the file server, as the enlarged image can be viewed on the portable terminal 300. Consequently, it prevents the user from inadvertently making an error of printing an unintended file and the generation of an unnecessary printing cost.

Moreover, if the displayed image is too small so that it is difficult to confirm the file contents, as only a thumbnail image is to be relied on, the user can always chose to view an enlarged image, thus making it more convenient.

It is obvious that this invention is not limited to the particular embodiments shown and described above but may be variously changed and modified without departing from the technical concept of this invention.

Although the descriptions of the above embodiments are made for a case of printing a file stored in a file storage device at a printing device based on an instruction from a portable terminal, the invention is not limited to it, but rather it is applicable to a case of transmitting a file stored in a file storage device to such a device as a personal computer based on an instruction from a portable terminal.

The means of conducting various processes in the file server as a file storage device can be realized by means of a dedicated hardware circuit, or a programmed computer. The program can be provided either by a computer readable recording medium such as a flexible disk and a CD-ROM, or by being supplied on-line via a network such as the Internet. In this case, the program recorded on a computer readable medium is normally transferred to a storage unit such as a hard disk and stored. The program can also be provided as independent application software or can be built into the software of the file storage device as a part of its function.

What is claimed is:

1. A file storage device that is capable of communicating with a portable terminal, comprising:
a text information extracting part for extracting text information for a specified file in response to a request from said portable terminal; and
a text information transmitting part for transmitting the text information extracted by said text information extracting part to said portable terminal.

2. A file storage device as claimed in claim 1, wherein said text information is a heading in the data included in said specified file.

3. A file storage device as claimed in claim 1, wherein said text information is obtained by recognizing characters from character image in the image data included in said specified file.

4. A file storage device that is capable of communicating with a portable terminal and a printing device, comprising:
an aggregate image generating part for generating an aggregate image consisting of a plurality of thumbnail images arranged within the same page for a specified file in response to a request from said portable terminal; and
an aggregate image transmitting part for transmitting the aggregate image generated by said aggregate image generating part to said printing device.

5. A file storage device that is capable of communicating with a portable terminal, comprising:
a thumbnail image transmitting part for transmitting a thumbnail image for a specified file to said portable terminal in response to a request from said portable terminal;
an enlarged image generating part for generating an enlarged image for said thumbnail image in response to a request from said portable terminal; and
an enlarged image transmitting part for transmitting the enlarged image generated by said enlarged image generating part to said portable terminal.

6. A printing system, comprising:
a file storage device for storing a file;
a printing device communicable with said file storage device; and
a portable terminal communicable with said file storage device, wherein
a file stored in said file storage device is printed by said printing device based on an instruction from said portable terminal;
said file storage device including:
a text information extracting part for extracting text information for a specified file in response to a request from said portable terminal; and
a text information transmitting part for transmitting the text information extracted by said text information extracting part to said portable terminal;
said portable terminal including:
a display part for displaying the text information received from said file storage device.

7. A printing system, comprising:
a file storage device for storing a file;
a printing device communicable with said file storage device; and
a portable terminal communicable with said file storage device, wherein
a file stored in said file storage device is printed by said printing device based on an instruction from said portable terminal;
said file storage device including:
an aggregate image generating part for generating an aggregate image consisting of a plurality of thumbnail images arranged within the same page for a specified file in response to a request from said portable terminal; and
an aggregate image transmitting part for transmitting the aggregate image generated by said aggregate image generating part to said printing device,
said printing device including:
a printing part for printing the aggregate image received from said file storage device.

8. A printing system, comprising:
a file storage device for storing a file;
a printing device communicable with said file storage device; and
a portable terminal communicable with said file storage device, wherein
a file stored in said file storage device is printed by said printing device based on an instruction from said portable terminal;
said file storage device including:
a thumbnail image transmitting part for transmitting a thumbnail image for a specified file to said portable terminal in response to a request from said portable terminal;
an enlarged image generating part for generating an enlarged image for said thumbnail image in response to a request from said portable terminal; and
an enlarged image transmitting part for transmitting the enlarged image generated by said enlarged image generating part to said portable terminal;
said portable terminal including:
a display part for displaying the thumbnail image and the enlarged image received from said file storage device.

9. A program for controlling a file storage device that is capable of communicating with a portable terminal, wherein said program causes said file storage device to execute a process comprising the steps of:
1) extracting text information for a specified file in response to a request from said portable terminal; and
2) transmitting the text information extracted in step 1) to said portable terminal.

10. A computer readable recording medium on which the program for controlling a file storage device as claimed in claim 9 is recorded.

11. A program for controlling a file storage device that is capable of communicating with a portable terminal and a printing device, wherein said program causes said file storage device to execute a process comprising the steps of:
1) generating an aggregate image consisting of a plurality of thumbnail images arranged within the same page for a specified file in response to a request from said portable terminal; and
2) transmitting the aggregate image generated in step 1) to said printing device.

12. A computer readable recording medium on which the program for controlling a file storage device as claimed in claim 11 is recorded.

13. A program for controlling a file storage device that is capable of communicating with a portable terminal, wherein said program causes said file storage device to execute a process comprising the steps of:
1) transmitting a thumbnail image for a specified file to said portable terminal in response to a request from said portable terminal;
2) generating an enlarged image for said thumbnail image in response to a request from said portable terminal; and
3) transmitting the enlarged image generated in step 2) to said portable terminal.

14. A computer readable recording medium on which the program for controlling a file storage device as claimed in claim 13 is recorded.
